(19) United States
(12) Patent Application Publication
(10) Pub. No.: US 2016/0084483 A1
(43) Pub. Date: Mar. 24, 2016

(54) ELECTRICALLY ISOLATED AND THERMALLY RADIATED LED MODULE

(71) Applicant: GE LIGHTING SOLUTIONS, LLC, East Cleveland, OH (US)

(72) Inventors: Eden DUBUC, Lachine (CA); Luigi TAVERNESE, Montreal (CA); Nam NS NGUYEN, Lachine (CA)

(21) Appl. No.: 14/752,992

(22) Filed: Jun. 28, 2015

Related U.S. Application Data
(60) Provisional application No. 62/053,776, filed on Sep. 22, 2014.

(51) Int. Cl. F21V 19/00; F21V 17/10; F21V 23/00; F21V 29/89; F21V 29/70; F21V 29/71; F21V 23/02; F21V 29/87

(52) U.S. Cl. CPC F21V 19/005; F21V 23/023; F21V 17/101; F21V 19/0035; F21V 29/87; F21V 29/89; F21V 29/70; F21V 29/713; F21V 23/009; F21V 23/006; F21Y 2101/02

(57) ABSTRACT

An electrically isolated light-emitting display (LED) module efficiently transfers heat away from electronic components by thermally conducting the heat to the outside walls of an enclosure. An embodiment includes a plastic enclosure having thin plastic walls that define an opening, a plastic cover having a lens and configured to cover the opening, a power supply unit (PSU), a light-emitting diode (LED) operably connected to the PSU, and a thermally conducting potting material. The potting material is deposited into an interior volume of the plastic enclosure to cover the PSU, contact a back portion of the LED, and to thermally connect the PSU and the LED to the thin plastic walls of the plastic enclosure without covering a front portion of the LED.

### FIELD OF THE INVENTION

The present disclosure generally relates to an electrically isolated light-emitting display (LED) module that efficiently transfers heat away from electronic components by thermally conducting the heat to the outside walls of an enclosure.

### BACKGROUND

LED modules are assemblies that include one or more light emitting diodes and electrical circuits which are typically enclosed inside a housing. Such LED modules are used for a wide variety of purposes, such as for railroad signals, traffic signals, street lights, and refrigerated display lighting (RDL).

In many LED modules, a known problem exists concerning extraction of heat from the power supply units (PSU) and LEDs. One conventional method of solving the heat extraction problem is to provide a metal enclosure and/or housing and to connect the LED module to the housing. However, such metal enclosures are electrically conductive, which could lead to a shock hazard, and are relatively expensive.

Another conventional method for solving the heat extraction problem is to use a heat sink connected to the LED module inside a plastic enclosure. But this method traps heat inside the plastic enclosure, leading to heat buildup and possible over-heating. Yet another conventional solution is to use a metal heat sink over-molded with plastic, but in this case the difference in thermal expansion coefficient sometimes impairs the stability of the seal for the enclosure. Another solution relates to under-driving the LEDs of the LED module in such manner that the component becomes less sensitive to heat, but such operation introduces inefficiencies which may be undesirable.

### SUMMARY OF THE INVENTION

Presented are apparatus and methods for providing an electrically isolated light-emitting display (LED) module that efficiently transfers heat away from electronic components by thermally conducting the heat to the outside walls of an enclosure. An embodiment includes a plastic enclosure having thin plastic walls that define an opening, a plastic cover having a lens and configured to cover the opening, a power supply unit (PSU), a light-emitting diode (LED) operably connected to the PSU, and a thermally conducting potting material. The potting material is deposited into an interior volume of the plastic enclosure to cover the PSU, contact a back portion of the LED, and to thermally connect the PSU and the LED to the thin plastic walls of the plastic enclosure without covering a front portion of the LED.

In another embodiment, a method for assembling an LED module includes affixing a light-emitting diode (LED) power supply unit (PSU) within an interior volume of a container comprising thin plastic walls, forming an LED sub-assembly by affixing an LED to a plastic cover such that the LED is aligned with a lens that permits light to pass through the plastic cover, and operably connecting the LED PSU to the LED. A potting material is then deposited into the interior volume of the container to cover the LED PSU and to thermally connect it to the interior surface area of the thin plastic walls of the container, and then the container is covered with the LED sub-assembly such that a back portion of the LED contacts the potting material without the potting material covering a front portion of the LED.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 is a side, cross-sectional view of a LED module assembly in accordance with an embodiment of the disclosure;

FIG. 2 is an exploded perspective view of another embodiment of an LED module assembly in accordance with some embodiments of the disclosure; and

FIG. 3 illustrates an assembled LED module assembly in accordance with the embodiment shown in FIG. 2.

### DETAILED DESCRIPTION

Embodiments described herein relate to LED modules having a relatively large power consumption. For example, LED modules that consume at least ten watts (10 W) of electrical power. For such LED modules, there is a need to dissipate the heat generated by the various electronic components (for example, heat generated by the driver circuitry, by the power supply components, and the like) and the LED light source(s). Thus, in some embodiments disclosed herein, an enclosure is provided for the LED module that is not electrically conductive and that contains a potting material which contacts the various electronic components and functions to conduct the heat therefrom and to spread the heat outward to the walls of the enclosure, which overcomes the problem of producing a hot spot. In addition, it has been found that it is desirable to use a major portion of the outer surface area of such an enclosure to dissipate the heat so that heat can be uniformly dissipated from the LED module.

Accordingly, some embodiments utilize a thin-walled plastic enclosure to house the LED module, and a potting material deposited therein is used to conduct heat away from the LED light source(s) and the electronic circuitry to minimize thermal resistance. In an implementation, an LED connected to a heat sink and to a power supply is installed within the plastic enclosure. Next, the plastic enclosure is filled, partially or wholly, with a potting material that is electrically nonconductive and thermally conductive, such as a silicone-based potting material. In some embodiments, the volume within the plastic enclosure that includes the heat sink and power supply is wholly filled with the potting material to eliminate air gaps, which is advantageous because heat can then be easily transferred via the potting material from the hot components to substantially the entire surface area of the exterior surfaces of the plastic enclosure. Thus, hot spots on the LED module may be minimized or eliminated because the heat is transferred uniformly to all of the outside walls of the plastic enclosure. In addition, such embodiments allow for all the electrical components to be thermally controlled, without the need to utilize multiple heat sinks. Furthermore, the plastic enclosure may be sealed in a manner that does not require gaskets or fasteners. Yet further, in some embodiments, due to the use of the potting material, the LED module and/or other electronic components within the plastic enclosure or container may advantageously be shock resistant and/or impact resistant and/or vibration resistant and/or fire resistant and/or water resistant. Such embodiments of an electrically isolated and thermally radiated LED module may therefore be suitable for use in extreme and/or harsh environments, for example, within a freezer display case having temperatures below the freezing point of water.

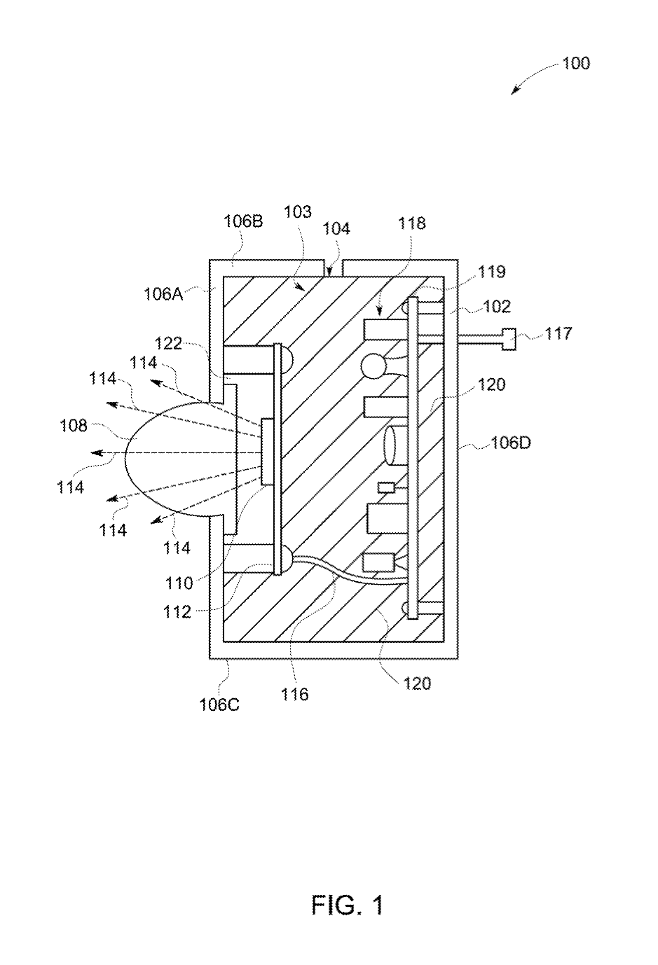

FIG. 1 is a schematic cross-sectional side view of an LED module assembly 100 according to some embodiments. It should be understood that the LED module assembly 100 can be formed into other shapes and/or sizes, and that the location of the various components shown in FIG. 1 may be different than that shown.

Referring to FIG. 1, the LED module assembly 100 includes a plastic housing or enclosure 102 that defines an interior volume 103 and includes a filling opening or aperture 104. The filling opening 104 may be closed or sealed with a plug (not shown) or other type of closure after a potting material is deposited therethrough (which will be explained below). In some embodiments, the walls of the enclosure 102 may be composed of a relatively thin plastic material, such as a polycarbonate material that may be approximately one and a half millimeters (1.5 mm) thick. In some embodiments, the plastic enclosure 102 includes a front wall 106A, first side wall 106B, second side wall 106C and rear wall 106D (it should be understood that, for ease of understanding, only four of the six enclosure walls are shown in FIG. 1). In some implementations, a lens 108 (or diffuser) is fitted through the front wall 106A as shown, and one or more LED chips 110 are mounted on a support 112 which is positioned behind the lens 108 within the interior volume 103 of the plastic enclosure 102. In some implementations, the support 112 is a heat sink, and features of the front wall 106 along with the support 112 may define an LED chip interior volume 122 that is separate and distinct from the interior volume 103. During assembly of the LED module assembly 100 (which will be described below), potting material may be deposited in such manner to fill the interior volume 103 but without filling the LED chip interior volume 103.

Referring again to FIG. 1, the LED chip(s) 110 are seated on the support 112 so as to be aligned with the lens 108 so that, during operation, light from the LED chip(s) 110 is emitted outwardly through the lens 108 and away from the front wall 106A of the plastic enclosure 102 in the directions of the dotted-line arrows 114. In some implementations, the support 112 of the LED chip(s) 110 may be a PCB (printed circuit board) and/or a metallic heat sink, and may include wiring 116. The wiring 116 may connect the LED chip(s) 110 to one or more electrical components, such as a power supply unit (PSU) 118. The PSU 118 may include electronic components on a support 119 (which may be a printed circuit board), and the electronic components may include one or more of transformers and/or driver circuits and/or capacitors and/or resistors and/or other electronic circuitry utilized to power the LED chip(s) 110 and/or control the operation of the LED chip(s) 110, for example, with regard to light output. In some embodiments, the PSU 118 includes a connector 117 for providing electrical power from an outside source, and the connector 117 may be over-molded through the back wall 106D of the plastic housing 102. It should be understood that many different types of connectors and/or wiring may be utilized to provide the power required to energize the LED chip(s) 110, and such connectors or wires may be located in one or more different portion(s) of the plastic housing. For example, in an implementation, a connector or wires may be threaded through the filling opening 104 before any potting material is deposited within the interior volume 103.

FIG. 1 also depicts a thermally-conductive silicone potting material 120 which has been deposited through the filling opening 104. In this embodiment, the potting material 120 fills the spaces between a back wall of the support 112 (or heat sink) for the LED chip(s) 110 and between the side walls 106B and 106C of the plastic enclosure 102, covers the components of the PSU 118, and fills the spaces between the support 119 of the PSU 118 and the rear wall or back wall 106D. It should be noted that, in the embodiment of FIG. 1, the support 112 is connected to the front wall 106A and includes barrier features that prevent the potting material 120 from entering the LED chip interior volume 122 (which volume is located between the lens 108 and the LED chip(s) 110). Thus, the potting material 120 fills the interior volume 103 of the plastic housing 102 without covering the LED chip(s) 110, and thus the potting material does not block any of the light output from the LED chip(s) 110. It should also be noted that, in some other embodiments, the potting material 120 may be deposited in such manner to only partially fill the interior volume 103 of the plastic enclosure 102, but deposited in enough quantity to ensure that heat from the various electrical components is thermally carried to at least some portions of the outside walls (such as walls 106C and 106D) to adequately dissipate heat to prevent overheating. In addition, in some implementations the thermally conductive silicone potting material 120 is added through the filling opening 104 while in a liquid or semi-liquid state, and then it may be partially or wholly cured after being added (which is explained below).

Once the LED module assembly 100 is completed and put into operation, the silicone potting material 120 facilitates heat transfer from the LED chips(s) 110 and heat sink 112, and from the PSU 118 and support 119 by providing pathways to the interior surface area of the outside walls 106A, 106B, 106C and 106D (and the walls that are not shown) of the plastic enclosure 102. The heat is then dissipated by these outside walls of the plastic enclosure 102 into the ambient air. In some embodiments, approximately fifty percent of the outside surface area of the walls 106A, 106B, 106C and 106D (and the walls that are not shown) radiate or convect heat outwardly away from the plastic enclosure 102 during operation of the LED module. It should be understood that potting compounds other than silicone-based compounds could be used as long as such alternate potting compounds provide adequate thermal conductivity and/or heat dissipation properties. In addition, potting compounds that are not transparent or opaque can be utilized with the embodiments described herein because the LED module assembly is configured such that when the potting compound is deposited within the plastic enclosure it does not cover the LED chip(s) 110. In some implementations, the amount of potting compound deposited within the volume of the plastic housing is controlled so as to avoid contact with the LED chip(s) and/or interior features (such as a barrier) of the front wall of the plastic housing 102 may be provided that prevent the potting compound from impinging on and/or covering the LED chip(s) 110 and/or the lens 108. Thus, in some embodiments an asphalt potting compound (which is less expensive than silicone potting materials) may be used as the potting material.

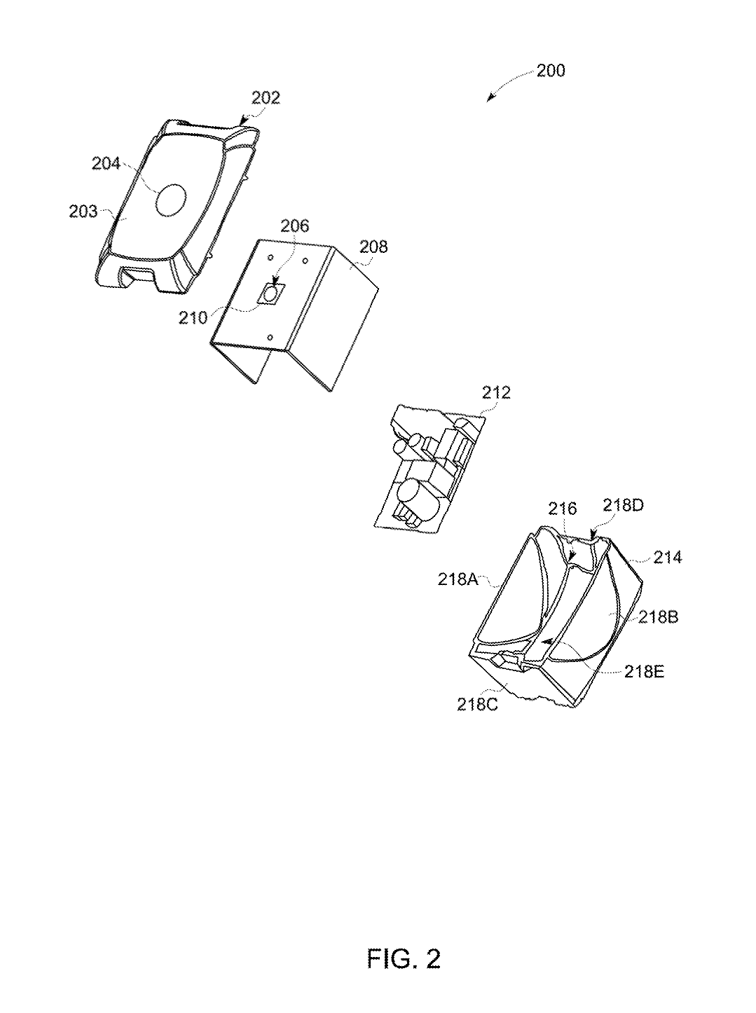

FIG. 2 is an exploded perspective view of an LED module assembly 200 according to some embodiments. A plastic front cover 202 of the plastic enclosure includes an exterior portion 203 having an optical lens 204 which may be a diffuser. A chip on board (COB) LED 206 may be thermally coupled to a heat sink 208 (which may be composed of aluminum) via a thermally conductive tape 210 that is positioned between the COB LED 206 and the aluminum heat sink 208. In some embodiments, the heat sink 208 is affixed to the plastic front cover 202 by screws, clips, press-fittings, or the like mechanical retention features in such manner to align the COB LED 206 with the optical lens 204 to form a front cover 202 and heat sink 208 sub-assembly. In addition, the front cover 202 may include interior barrier features (not shown) such that, when the head sink 208 is affixed to the front cover, a COB LED interior volume (not shown) is formed which prevents potting material from covering and/or blocking the COB LED 206 from the optical lens 204.

Referring again to FIG. 2, the LED module assembly 200 may also include an LED driver assembly 212 (or power supply unit (PSU)) that includes various electronic components (as shown), and a plastic housing 214. The plastic housing 214 defines an interior volume 216 which is defined by thin plastic side walls 218A, 218B, 218C and 218D along with back wall 218E. In some embodiments, the LED driver assembly 212 may include an electrical connector (not shown) for receiving power from an outside source, and is affixed within the plastic housing 214 by using screws, clips or other types of mechanical connectors to form a back cover and LED driver sub-assembly. As explained above, the electrical connector may be over-molded through a wall of the plastic housing 214 during manufacture of the housing, and then connected to the LED driver assembly 212 during assembly of the LED module assembly 200. In some embodiments, before affixing the front cover 202 to the plastic housing 214, a silicone potting compound is poured onto the interior volume 216 to cover the components of the LED driver 212 and wholly or partially fill the interior volume 216. The front cover 202 and heat sink 208 sub-assembly is then affixed to the plastic housing 214 and LED driver 212 sub-assembly, for example by press-fitting features (not shown) on the interior portion of the front cover 202 to the top portions of the side walls 218A-218D (without using any mechanical fasteners) such that the silicone potting compound contacts the lower outside portion of the heat sink 208 (on the side opposite the COB LED 206), without covering the COB LED 206 so as not to obscure light therefrom. In particular, the outside interior edges of the front cover 202 are press-fit to the top edges of the side walls 218A-218D to form a closed plastic-walled enclosure that houses the COB LED 206, the heat sink 208, the LED driver assembly 212, and the silicone potting material, wherein the potting material partially or wholly fills the interior volume 216 and contacts the side walls 218A-218D, bottom wall 218E and, in some implementations, at least a portion of the interior surface of the front cover 202.

In some embodiments, the front cover 202 and heat sink 208 sub-assembly is press-fit to the plastic housing 214 and LED driver 212 sub-assembly, and then a potting material is poured into the interior volume through a fill hole (not shown in FIG. 2). In an implementation, the fill hole may be located in the back wall 218E, but other locations could also be used.

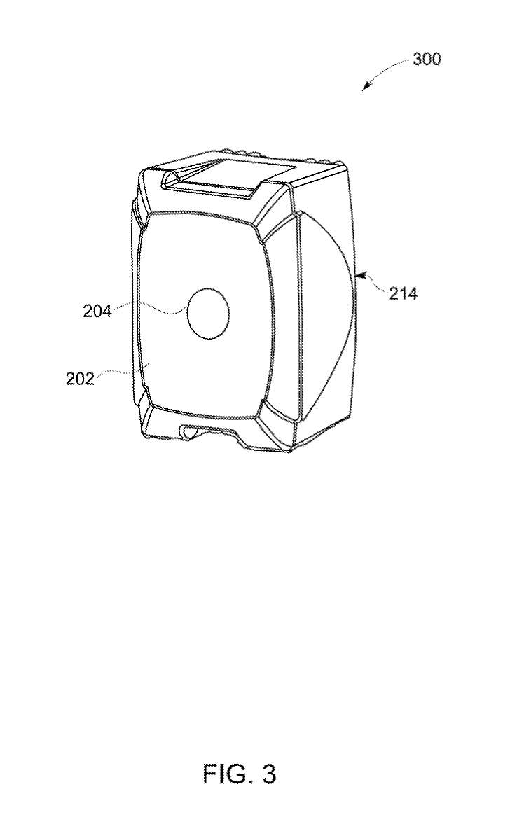

FIG. 3 illustrates an assembled LED module assembly 300 according to an embodiment. In particular, the front cover 202 is shown press-fit to the plastic housing 214 and the potting material (not shown) has already been deposited or poured into the interior volume 216 (see FIG. 2) as described above. In some embodiments, the LED module assembly 300 is then placed into an oven at sixty degrees centigrade (60° C.) for about one hour to allow the silicone potting compound to cure. Once cured, the silicone potting compound acts as a thermally conductive interface that thermally couples the LED driver 212 and the heat sink 208 to the plastic walls 218A-218E and to at least a portion of the plastic cover 202 to lower the overall thermal resistance of the LED module assembly 300. The silicone potting compound may also beneficially acts as a strain relief mechanism for the connector or power input wires (not shown), may improve vibration and impact resistance, may prevent components from moving and/or failing by holding the various components in place, and provides a fully sealed LED module assembly.

The technical advantages of the LED module assembly embodiments described herein include providing an LED module assembly that provides superior thermal dissipation characteristics, and that includes electronic components that are isolated from harsh environments. Thus, overall reliability and durability are improved. In addition, the disclosed LED module assemblies can be utilized for many different and/or diverse applications, for example, to provide light in freezer display cases while operating in low temperatures, to provide light in greenhouses having high humidity, and to provide lighting in outside environments, for example in a street lamps or signal lamps or outside household lamps, that may be subject to high temperatures, low temperatures, high winds, rain, sleet and/or snow and/or vibration depending on the location and/or season of the year.

It should be understood that the above descriptions and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. An LED module assembly comprising:
a plastic enclosure having thin plastic walls providing an interior volume, and wherein a top portion of the walls defines an opening;
a plastic cover comprising a lens and configured to cover the opening;
a power supply unit (PSU) comprising electronic components connected to a PSU substrate, the PSU situated within the interior volume of the plastic enclosure;
a light-emitting diode (LED) operably connected to the PSU and situated within the interior volume of the plastic enclosure such that the LED is aligned with the lens of the plastic cover; and
a thermally conducting potting material deposited into the interior volume of the plastic enclosure such that it covers the PSU electronic components, contacts a back portion of the LED, and thermally connects the PSU, the PSU substrate and the LED to the thin plastic walls of the plastic enclosure without covering a front portion of the LED.

2. The LED module of claim 1, wherein the plastic cover comprises a barrier that prevents the thermally conducting potting material from covering the front portion of the LED.

3. The LED module assembly of claim 1, wherein the plastic cover comprises features for press fitting to the opening of the plastic enclosure.

4. The LED module assembly of claim 1, further comprising a metal heat sink operably connected to the LED.

5. The LED module assembly of claim 1, further comprising a connector operably connected to the PSU and extending through a wall of the plastic enclosure.

6. The LED module assembly of claim 1, wherein the potting material comprises one of a silicon composition or an asphalt composition.

7. The LED module assembly of claim 1, wherein the LED comprises a chip on board (COB) LED.

8. The LED module assembly of claim 7, wherein the COB LED is thermally coupled to a metallic heat sink via a thermally conductive tape.

9. The LED module assembly of claim 1, wherein the electrical components of the PSU comprise at least one of transformers, driver circuits, capacitors and resistors.

10. A method for assembling an LED module comprising:
affixing a light-emitting diode (LED) power supply unit (PSU) within an interior volume of a container comprising thin plastic walls;
forming an LED sub-assembly by affixing an LED to a plastic cover such that the LED is aligned with a lens that permits light to pass through the plastic cover;
operably connecting the LED PSU to the LED;
depositing a potting material into the interior volume of the container to cover the LED PSU and to thermally connect it to the interior surface area of the thin plastic walls of the container; and
covering the container with the LED sub-assembly such that a back portion of the LED contacts the potting material without the potting material covering a front portion of the LED.

11. The method of claim 10, wherein covering the container comprises press fitting the plastic cover of the LED sub-assembly to an opening formed by the walls of the plastic container.

12. The method of claim 10, further comprising, prior to operably connecting the LED PSU to the LED, operably connecting a metal heat sink to the LED.

13. The method of claim 12, wherein operably connecting a metal heat sink to the LED comprises thermally coupling the metallic heat sink via a thermally conductive tape to the LED.

14. The method of claim 10, further comprising operably connecting the PSU to a connector which extends through a wall of the plastic enclosure.

15. The method of claim 10, wherein depositing the potting material comprises one of a depositing a silicon composition or depositing an asphalt composition.

16. The method of claim 10, further comprising placing the assembled LED module into a heated oven to cure the potting material.

17. A method for assembling an LED module comprising:
mounting at least one LED to a heat sink to form an LED sub-assembly;
affixing the LED sub-assembly to a front cover to form a front cover sub-assembly;
affixing an LED power supply unit (PSU) within an interior volume of a container comprising thin plastic walls;
operably connecting the LED PSU to the LED sub-assembly;
press-fitting the front cover sub-assembly to the container such that the LED sub-assembly is within the interior volume of the container; and
depositing a potting material into the interior volume via a fill hole to at least partially fill the interior volume of the container such that LED PSU and the LED sub-assembly are thermally connected to the interior surface area of the thin plastic walls of the container without covering the at least one LED.

18. The method of claim 17, wherein affixing the LED sub-assembly to the front cover comprises aligning the LED to a lens in the front cover and using at least one mechanical retention feature to connect the LED sub-assembly to the front cover.

19. The method of claim 17, wherein mounting the at least one LED to the heat sink comprises using a thermally conductive tape to thermally couple the metallic heat sink to the LED.

20. The method of claim 17, further comprising operably connecting the LED PSU to a connector which extends through a wall of the plastic enclosure.

21. The method of claim 17, wherein depositing the potting material comprises one of depositing a silicon composition or depositing an asphalt composition.

22. The method of claim 17, further comprising placing the assembled LED module into a heated oven to cure the potting material.
